(19) United States
(12) Patent Application Publication
(10) Pub. No.: US 2013/0299045 A1
(43) Pub. Date: Nov. 14, 2013

(54) Viscous Liquid Transfer Device

(71) Applicant: Antonio Fracasso, Lasalle (CA)

(72) Inventor: Antonio Fracasso, Lasalle (CA)

(21) Appl. No.: 13/850,553

(22) Filed: Mar. 26, 2013

(30) Foreign Application Priority Data
May 11, 2012 (CA) 2777005

(51) Int. Cl. B67C 11/02; B65B 39/06

(52) U.S. Cl. CPC B67C 11/02; B65B 39/06
USPC 141/332

(57) ABSTRACT

This device is used to transfer viscous liquids such as ketchup, shampoo, oil, etc., from one bottle to another bottle. It functions like a funnel but its structure and material composition (plastic/rubber) allows it to hold both containers so that they would stay in place. Usually, the top bottle has very little liquid and the bottom bottle is almost full. The weight of the fuller bottom bottle would insure that the system would not topple over. This saves the unused liquid instead of throwing it out. Combining several similar devices allows for the transfer of viscous liquid from a smaller bottle to a bigger bottle and vice-versa.

### FIELD OF THE INVENTION

This invention relates to a viscous liquid transfer device and, more particularly, to one for emptying partially filled bottles with liquids such as ketchup or shampoo and transferring the contents into a fuller bottle.

### BACKGROUND OF THE INVENTION

When small amounts of viscous liquids are left in a bottle, such as Ketchup, the remaining substance cannot be emptied in a reasonable amount of time. You would need to hold the bottle upside down for a long duration to completely empty it. This could take hours. Usually, the small amount remaining is thrown out causing waste and a loss of money.

Some inventions have been designed to remedy this problem but none have gone to market because they would be expensive to manufacture, over-designed or not very versatile. The following are all United States patents but none of them perform all of the functions that this invention can. Some cannot transfer viscous liquids from two bottles of different sizes or use bottles with short necks, such as shampoo bottles. Most of those inventions only suit long neck bottles such as the ketchup bottle.

| | |
|---|---|
| 3,877,499 | Alfred Fluster |
| 3,963,063 | Robert S. Pascarella |
| 4,217,941 | Vitale Catalano |
| 4,347,879 | Anton J. Blaser |

### SUMMARY OF THE INVENTION

This invention uses a device that works like a funnel which holds two bottles when transferring viscous liquids from a nearly empty top bottle to a nearly full bottom bottle. Because of its structure and material that has rubbery and elastic characteristics, the two bottles will stay in place when the device is forcefully inserted in the bottom bottle and the top bottle is forcefully inserted in it. The material must also be non toxic so that edible food can be transferred.

The bottom bottle is usually almost full and its weight will ensure that the structure will not topple over.

The design of the device also ensures that bottles with short necks can be used. Having a spout with a half inch long neck is all that is needed for the device to work. Shampoo bottles would fall into this category.

The basic shape of the device is repeated into smaller and bigger sizes. Combining the similar devices allows us to transfer viscous liquids from two bottles of different sizes.

When transferring viscous liquid from an almost empty bottle to a fuller bottle the amount of liquid in the emptier bottle will not create a blockage where the two bottles meet due to the small amount of liquid being transferred and its speed. This will permit for an opening to exist, allowing the air to be displaced from the fuller bottle to the emptier bottle.

Once the setup is done, the user can leave the structure in place and after an hour or so, all of the substance of the top bottle will be displaced to the bottom bottle.

### BRIEF DESCRIPTION OF THE DRAWINGS

FIG. 1 is a three dimensional view of the invention.

FIG. 2 is an example of how the invention is used.

FIG. 3 is a cut-away view showing the height, angle of the sides and wall thickness of the invention.

Table 1 gives the inner diameters of the invention pieces whose dimensions are given in thousandths of an inch.

FIG. 4 is a three dimensional view of the invention pieces inserted in one another.

FIG. 5 is an example showing how the invention is used when transferring viscous liquid from a smaller bottle to a bigger bottle.

FIG. 6 is an example showing how the invention is used when transferring viscous liquid from a bigger bottle to a smaller bottle.

Table 2 gives the sequence of how to stack the pieces when transferring viscous liquid from a bigger bottle to a smaller bottle.

FIG. 7 shows a stacking sequence of the invention.

FIG. 8 shows a stacking sequence of the invention.

FIG. 9 shows a stacking sequence of the invention.

### DETAILED DESCRIPTION

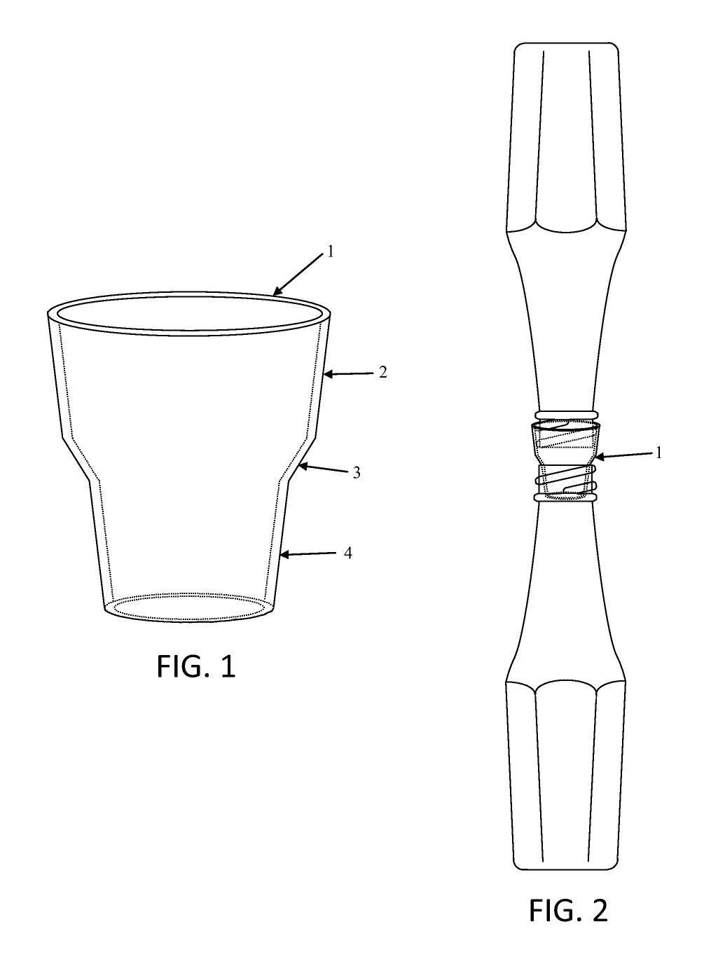

FIG. 1 shows the basic design of the liquid transfer device 1. The device has three sections; the top 2, the middle 3 and the bottom 4. FIG. 2 shows how the liquid transfer device 1 is used in its most basic way. The bottom 2 is forced into the head of the bottom, fuller bottle, simply by using the person's hand, and positioned as close to the middle 3 as possible. Since the device is made of a rubbery/elastic material not much force will be needed to achieve a secured fit. The top nearly empty bottle is then inverted and placed in the top 2 of the device. Again, applying a reasonable amount of force to achieve a secured fit, as close to the middle 3 as possible. The top bottle should be placed perpendicular to the ground to insure that the structure will not tip over. Once the setup is done, the transfer of viscous liquid from the top bottle to the bottom bottle will commence.

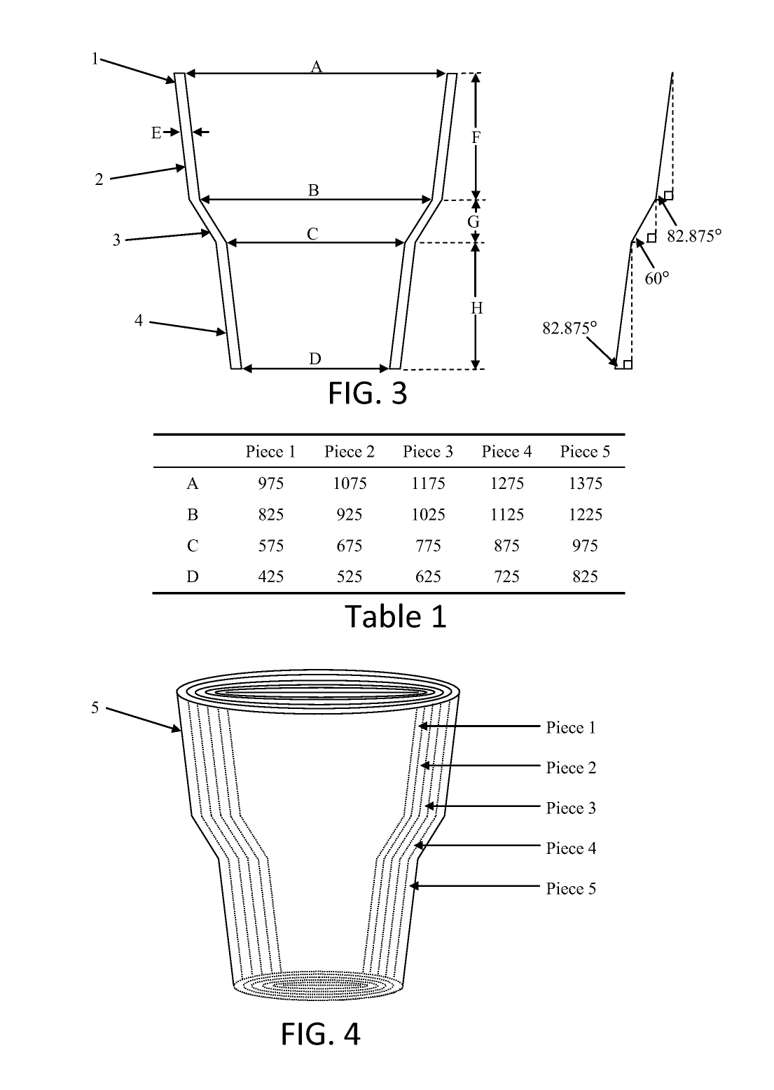

The FIG. 3 shows the dimensions of the liquid transfer device 1. All sections are shaped in the form of a cut-off cone. The top 2 and the bottom 4 sections have angles of about 82.875°. The middle 3 has an angle of about 60°, which is done so that the top bottle would be as close to the ground as possible to ensure a lower center of gravity. The width of the wall E is about 0.05 inches. The length of F and H is about 0.6 inches and the length of G is about 0.2 inches.

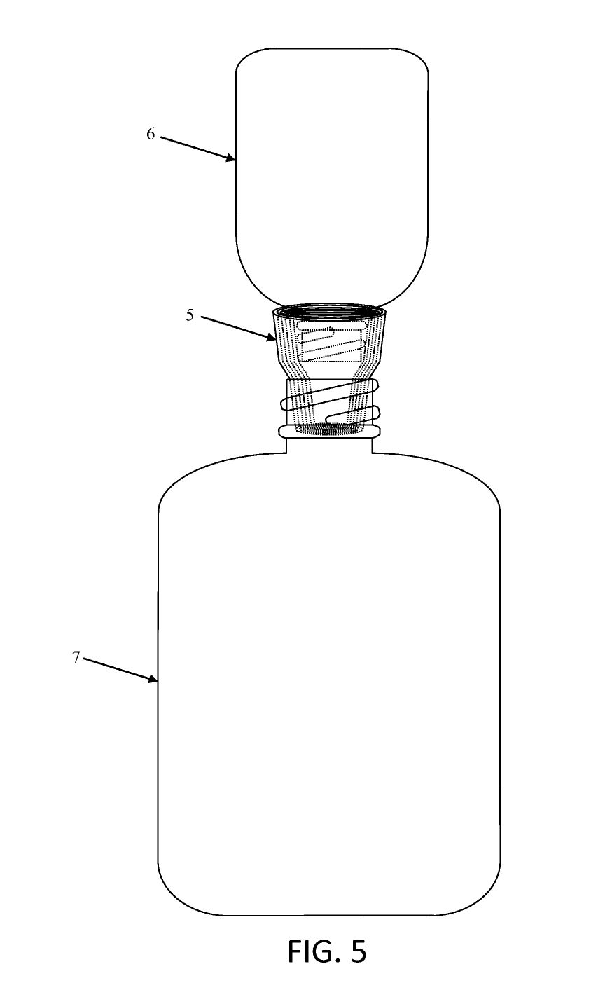

In order to transfer viscous liquids from different sized bottles, many liquid transfer device pieces of the same basic shape 1 will be needed. Table 1 specifies the inner diameters of liquid transfer device pieces. These values are roughly the values that would be used when producing the liquid transfer device pieces. Note the difference between any adjacent cells is twice E, which equals 0.1 if we use E equals 0.05. More pieces, bigger or smaller can be added to the table but the rule with adjacent cells being twice E must always be respected. FIG. 4 shows all the liquid transfer device pieces 5 inserted in each other. FIG. 5 shows how liquid transfer device pieces 5 are used to transfer viscous liquid from a smaller bottle 6 to a bigger bottle 7. Choosing the appropriate piece for the bigger bottle 7, then we just keep adding pieces until a proper fit is made for the smaller bottle 6.

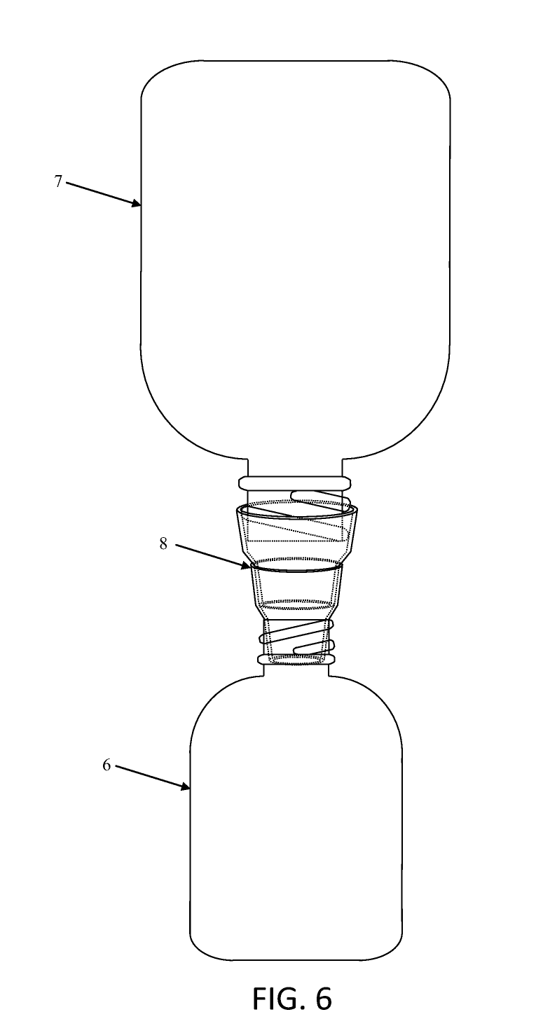

FIG. 6 shows that a bigger bottle 7 can transfer viscous liquid to a smaller bottle 6. The bigger bottle 7 is nearly empty and the smaller bottle 6 is almost full which will ensure that the structure will not topple over. The arrangement of pieces 8 is described in Table 2.

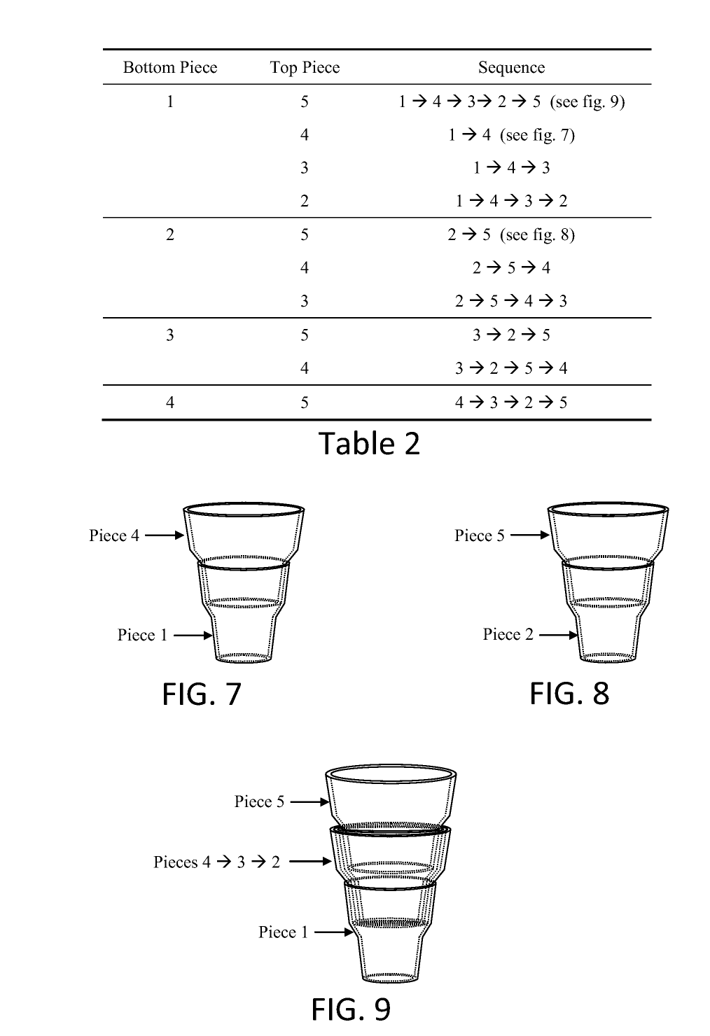

Some pieces fit perfectly inside other pieces for placing big bottles on top of small bottles. This is the case for Pieces 1 and 4 and for Pieces 2 and 5 shown in FIGS. 7 and 8 respectively. For example, from Table 1, we see that for Piece 4, D=0.725 inches and for Piece 1, B=0.825 inches, therefore the pieces would fit perfectly as shown in FIG. 7 with no space between the touching parts. FIG. 9 also shows the same concept going from the smallest Piece 1 to the biggest Piece 5. Note that Piece 2 is completely immersed in Piece 3 which is completely immersed in Piece 4.

What is claimed is:

1. A device made of a rubbery/elastic material shaped in the form of three joined open ended cones whose diameter gets progressively larger to accommodate the transfer of viscous liquid by linking together a top nearly empty bottle to a bottom, nearly full bottle, much like the function of a funnel.

2. The device of claim 1 which can transfer viscous liquid from a nearly empty bottle having a half inch long neck or greater to a nearly full bottle having a half inch long neck or greater.

3. The device of claim 1 whose basic shape is copied into smaller and bigger pieces and when inserted into each other, the transfer of viscous liquid can be accomplished from a smaller bottle to a bigger bottle.

4. The device of claim 1 whose basic shape is copied into smaller and bigger pieces and when arranged in a certain sequence, the transfer of viscous liquid can be accomplished from a bigger bottle to a smaller bottle.
